(19) United States
(12) Patent Application Publication
(10) Pub. No.: US 2015/0175151 A1
(43) Pub. Date: Jun. 25, 2015

(54) METHOD FOR OPERATING A HYBRID DRIVE DEVICE

(71) Applicant: Robert Bosch GmbH, Stuttgart (DE)

(72) Inventors: Kaspar Schmoll Genannt Eisenwerth, Vaihingen-Horrheim (DE); Ralf Schuler, Plochingen (DE)

(21) Appl. No.: 14/573,408

(22) Filed: Dec. 17, 2014

(30) Foreign Application Priority Data
Dec. 19, 2013 (DE) 10 2013 226 611.1

(51) Int. Cl. B60W 20/00; B60W 10/30; B60W 10/02; B60W 10/06; B60W 10/08

(52) U.S. Cl. CPC B60W 20/10; B60W 10/06; B60W 10/08; B60W 10/02; B60W 10/30; Y10S 903/93

(57) ABSTRACT

A method for operating a hybrid drive device for a motor vehicle. The hybrid drive device includes at least one first drive unit and one second drive unit. The first drive unit and the second drive unit can be operatively connected mechanically by means of a clutch. To start the first drive unit, the clutch is at least partially closed, and the first drive unit is thus accelerated by means of the second drive unit. During the starting of the first drive unit, the second drive unit is operated with speed regulation.

### BACKGROUND OF THE INVENTION

The invention relates to a method and a device for operating a hybrid drive device, in particular for a motor vehicle, which has at least one first drive unit and at least one second drive unit. The first and the second drive unit can be operatively connected mechanically by means of a clutch. The first drive unit is started by at least partially closing the clutch and thus accelerating the first drive unit by means of the second drive unit.

A large number of methods and devices for operating a hybrid drive device which has a first drive unit and a second drive unit are now known from the prior art. In hybrid drive devices of this kind, the first and the second drive unit can generally be operatively connected to one another mechanically by means of a clutch. In the “parallel hybrid”, the output shaft of the first drive unit and an input shaft of the second drive unit are operatively connected to one another by means of the clutch. In this case, the clutch can be acted upon by a vehicle control system. Through appropriate setting of the clutch, not only all the operating modes of hybrid driving, boost and recuperation but also driving exclusively with the second drive unit are possible. In the latter case, the clutch is open and the first drive unit is not in operation. If the first drive unit is an internal combustion engine, for example, this can be connected to the second drive unit and started by means of at least partial closure of the clutch. During this process, the rotating second drive unit drag-starts the first drive unit operatively connected by means of the clutch.

For initial starting or restarting the internal combustion engine, the output torque of the second drive unit, e.g. of an electric motor, is increased by a specifiable amount. At the beginning of the starting process, the clutch is open and, during the process, is moved into a position in which it transmits exactly this specified amount of the torque to the internal combustion engine. Based on the output, there is thus no change in torque during the starting process, and therefore the starting process is not perceptible to the driver. According to the prior art, the process is subject to purely “open loop” control. Owing to various disturbances in the clutch system, it may be that the torque/travel relationship at the clutch is not known precisely and therefore that the specified amount of torque at the clutch cannot be set exactly. Depending on the resulting deviation in the torque between the clutch and the electric motor, this may be felt by the driver as an uncomfortable jerk. In the case of systems with an automatic converter as a starting element, there is the additional difficulty that this torque error leads to a change in the converter slip, i.e. the speed difference between the pump impeller and the turbine wheel, and this leads to an even greater torque error at the transmission input shaft owing to the converter-specific properties, in particular the torque multiplication. There are therefore a large number of estimation modules and adaptations which adapt the torque/travel relationship in a regular manner during driving. This represents a considerable application outlay and a source of errors. Moreover, it is nevertheless not possible to establish an exact torque/travel relationship in every operating state.

Through adjustment of the contact force with which the clutch friction linings of the clutch are pressed against one another, it is possible, by means of the vehicle control unit, to control the amount of torque or slipping torque actually transmitted by the clutch in the slipping state. If the clutch is operated with slip, the first drive unit and the second drive unit rotate at different speeds. However, a slipping torque specified by means of the vehicle control unit only seldom corresponds to the slipping torque actually transmitted by the clutch since varying friction coefficients of the clutch friction linings due to wear or temperature changes, hydraulic or mechanical inaccuracies in the actuating system of the clutch, hysteresis, signal propagation times, aging and similar processes produce inaccuracies in control. The time from which a torque is transmitted during the closure of the clutch is therefore also subject to uncertainties.

During the drag-starting of an internal combustion engine, the second drive unit must overcome or absorb greatly varying negative and positive torques of the internal combustion engine during the changeover from unpowered to powered operation. In addition, the torque acting on the second drive unit is dependent on the actually transmitted slipping torque of the clutch during the starting of the internal combustion engine. These torque fluctuations affect, that is to say retard or accelerate, the speed of the second drive unit. The second drive unit is connected to the driven wheels. A change in the speed thereof can thus have a negative effect on handling and can impair the comfort of the vehicle.

DE 10 2007 062 796 discloses a method in which these torque fluctuations are minimized or eliminated by means of a knowledge of the slipping torque transmitted and the corresponding control of the clutch.

However, the complex determination of the slipping torque transmitted is necessary for this solution. Consequently, there is a search for a technical solution for operating a hybrid vehicle comfortably, even without determining the slipping torque transmitted by the clutch.

### SUMMARY OF THE INVENTION

A method for operating a hybrid drive device, in particular for a motor vehicle, is therefore provided. The hybrid drive device has at least one first drive unit and one second drive unit. The first drive unit and the second drive unit can be operatively connected mechanically by means of a clutch. The first drive unit is started by at least partially closing the clutch and thus accelerating the first drive unit by means of the second drive unit. According to the invention, the speed of the second drive unit is regulated during the starting of the first drive unit.

For control of the drive units, desired torques are normally specified. By regulating the speed of the second drive unit during the starting of the first drive unit, the speed fluctuations due to the drag-starting of the first drive unit and the lack of accurate control of the torque actually transmitted by means of the clutch are directly counteracted. For effective avoidance of the speed fluctuations at the driven wheels, the selected control rate for speed regulation is significantly higher than the buildup of individual oscillations of the torque. During the starting process, the second drive unit is thus used to eliminate an incorrect torque/travel relationship in the clutch control system.

It is thus advantageously achieved that the hybrid drive device is operated without unwanted speed fluctuations and accelerations at the output or at the driven wheels. Safe handling and comfortable driving are thus made possible even during the starting of the second drive unit. The quality of starting is thus further improved. The application outlay for the clutch system can be considerably reduced since the estimation models and adaptations required are not so detailed. In particular, feedforward control of the clutch may even be sufficient.

In another embodiment of the invention, the hybrid drive device furthermore has a torque converter and an output. The torque converter comprises a pump impeller and a turbine wheel. The second drive unit and the pump impeller are connected mechanically in a rigid manner to one another, and the turbine wheel is connected rigidly to the output. The output, in turn, is connected either rigidly or by means of a transmission to the driven wheels. During the starting of the first drive unit, the speed of the second drive unit is regulated, the speed of the second drive unit being regulated in accordance with the speed of the turbine wheel.

In this embodiment, the driven and rotating pump impeller of the torque converter imparts rotation to a hydraulic fluid within the torque converter. The rotating hydraulic fluid in the torque converter transmits a force or a torque to the turbine wheel, which is subject to an accelerating force as a result and thus also rotates. The speed of the second drive unit is then regulated in accordance with the speed of the turbine wheel, i.e. the speed actually acting at the output or at the driven wheels.

Even more accurate regulation of the speed of the second drive unit is advantageously effected, and thus even safer handling with further enhanced comfort is thus made possible.

In another embodiment of the invention, the speed of the second drive unit is regulated in accordance with the speed of the pump impeller.

The second drive unit is rigidly connected to the pump impeller of the torque converter. The effect of regulating in accordance with the speed of the pump impeller thus corresponds to speed regulation using the speed of the second drive unit.

In this regulation, it is advantageously possible to dispense with an additional sensor system for determining the speed of the second drive unit, and it is nevertheless possible to regulate the second drive unit in accordance with the speed of the second drive unit. Given appropriate design of the control circuit, safe handling combined with a high level of comfort is made possible with this regulation too. For this purpose, once again, a selected control rate of the control circuit is significantly greater than the buildup of individual oscillations of the torque.

In another embodiment of the invention, the speed of the second drive unit is operated with regulation in accordance with the speed difference between the speed of the turbine wheel and the speed of the pump impeller.

The speed difference between the turbine wheel and the pump impeller is the origin of the torque actually acting on the output or the driven wheels. It is thus possible, by regulating the speed of the second drive unit in accordance with the speed difference between the speed of the turbine wheel and the speed of the pump impeller, to set the torque actually acting on the output or the driven wheels.

A way of selectively influencing handling or of ensuring safe handling combined with a high level of comfort without torque fluctuations is advantageously achieved in this way.

In one embodiment of the invention, the speed of the second drive unit is regulated in such a way that the speed difference between the speed of the turbine wheel and the speed of the pump impeller remains constant.

If the difference between the turbine wheel speed and the pump impeller speed remains constant during the starting process of the first drive unit, the effective torque at the output or the driven wheels also remains constant.

This means that if the vehicle is accelerated just before the starting of the first drive unit, the vehicle continues to accelerate continuously with a constant acceleration; if it is being driven at a constant speed at that moment the speed continues to be maintained; or, if it is being decelerated at that moment, it continues to decelerate at a constant deceleration. The starting of the first drive unit lasts less than one second. Maintenance of a previous acceleration for this period of time is not felt to be troublesome on the part of the occupants in a vehicle having this hybrid drive device, for example.

Operation of the hybrid drive device which, on the one hand, ensures very comfortable driving and, on the other hand, safe handling is thus advantageously made possible since unwanted torque fluctuations during starting of the first drive unit are avoided.

In another embodiment of the invention, the value of the speed difference to be set between the speed of the turbine wheel and the speed of the pump impeller is specified in accordance with a parameter value detected by means of a sensor device during the operation of the hybrid drive device, in particular immediately before the starting of the first drive unit.

By virtue of the fact that the difference between the pump impeller speed and the turbine wheel speed is specified in accordance with a parameter value detected by means of a sensor device during the operation of the hybrid drive device, in particular immediately before the starting of the first drive unit, the hybrid drive device responds accordingly to external or internal environmental information and adapts the handling and comfort of the vehicle to the current situation. External environmental information could be weather conditions, such as snowy, wet or dry roads at different temperatures with correspondingly different friction coefficients, significant hill climbs or descents, for example. Internal environmental information for the hybrid drive device could be temperatures of the first or second drive unit, of power electronics, a state of charge of an energy supply device of the second drive unit or significantly sharp accelerations or decelerations of the vehicle, for example. Depending on how greatly one of these detected parameter values differs from the normal value or average value thereof, the value of the speed difference to be set is increased or lowered. By increasing it, an increase in the torque acting at the output or the driven wheels during the starting of the first drive unit is achieved. Increasing the difference is employed especially in the case of significant upward slopes, at a low temperature of the first drive unit or in the case of sharp acceleration of the vehicle. The increase is thus advantageously employed when safe handling is assisted and driving comfort is enhanced by an increased torque at the output or the driven wheels.

A reduction in the torque acting at the output or the driven wheels during the starting of the first drive unit is achieved by reducing the difference. Reducing the difference is employed particularly in the case of snowy and/or wet roads at low temperatures with a correspondingly low friction coefficient, for example, in the case of significant downhill slopes, or at a high temperature of the first drive unit, in the case of a low state of charge of an energy supply device of the second drive unit or in the case of sharp deceleration of the vehicle. The reduction is thus advantageously employed when safe handling is assisted and driving comfort is enhanced by a reduced torque at the output or the driven wheels.

Moreover, a device comprising at least one control unit for operating a hybrid drive device, in particular for a motor vehicle, which has at least one first drive unit and one second drive unit, is provided. In this case, the first drive unit and the second drive unit can be operatively connected mechanically by means of a clutch. The control unit controls the clutch in such a way for the purpose of starting the first drive unit that the clutch is at least partially closed and the first drive unit is thus accelerated by means of the second drive unit. In this case, the at least one control unit regulates the speed of the second drive unit during the starting of the first drive unit.

During the starting of the first drive unit, the speed fluctuations due to the drag-starting of the first drive unit are directly counteracted by means of the speed regulation of the second drive unit.

The device thus advantageously allows operation of the hybrid drive device without unwanted speed fluctuations and accelerations at the output or at the driven wheels.

Moreover, a hybrid drive device comprising at least one first and one second drive unit, a clutch and a device comprising a control unit, in particular for a motor vehicle, is provided. The first drive unit and the second drive unit can be operatively connected mechanically by means of the clutch. The control unit controls the clutch in such a way for the purpose of starting the first drive unit that the clutch is at least partially closed and the first drive unit is thus accelerated by means of the second drive unit. In this case, the at least one control unit regulates the speed of the second drive unit during the starting of the first drive unit.

During the starting of the first drive unit, the speed fluctuations due to the drag-starting of the first drive unit are directly counteracted by means of the speed regulation of the second drive unit.

A hybrid drive device which allows operation without unwanted speed fluctuations and accelerations at the output or at the driven wheels is thus advantageously made possible.

It is self-evident that the features, characteristics and advantages of the method according to the invention apply or can be applied in a corresponding fashion to the device according to the invention and to the hybrid drive device and vice versa.

### BRIEF DESCRIPTION OF THE DRAWINGS

Further features and advantages of embodiments of the invention will become apparent from the following description with reference to the attached drawings.

The invention will be explained in greater detail below by means of a number of figures, of which:

FIG. 1 shows a hybrid drive device for a motor vehicle in a schematic illustration,

FIG. 2 shows an illustrative embodiment of the advantageous method for operating the hybrid drive device of FIG. 1,

FIG. 3 shows an illustrative embodiment of a control system for operating the hybrid drive device of FIG. 1

### DETAILED DESCRIPTION

FIG. 1 shows an illustrative embodiment of a hybrid drive device 1 in a schematic illustration. The hybrid drive device 1 has a first drive unit 2, in particular an internal combustion engine, and a second drive unit 3, in particular an electric or hydraulic machine. These two drive units 2 and 3 are operatively connected by means of a clutch 4. When the clutch 4 is open, i.e. when the clutch disks of the clutch 4 are separated from one another, no torque is transmitted between the two drive units 2 and 3. The two drive units 2 and 3 can have any different speeds in this coupling state. When the clutch 4 is fully closed, i.e. the clutch disks rest one upon the other and are pressed against one another, both drive units 2 and 3 have the same speed and full transmission of a torque of one drive unit to the other is possible. When the clutch 4 is neither open nor fully closed, i.e. is partially closed, the two clutch disks slip on one another. This means that the drive units 2 and 3 have different speeds. Part of the torque of one drive unit is transmitted to the other drive unit. The speed difference between the two drive units 2 and 3 is thereby reduced. The drive units 2 and 3 can thus be separated from one another and connected by means of the clutch 4, and can thus be operatively connected by means of the clutch 4. To start the first drive unit 2, in particular an internal combustion engine, the clutch 4 is at least partially closed, and the clutch disks thus slip or are rigidly connected to one another. As a result, the torque of the second drive unit 3 is transmitted to the first drive unit 2, which consequently begins to rotate. When the first drive unit 2 is running independently or can output a torque itself or by itself, the starting of the first drive unit 2 is finished. During the starting or starting process, in which the first drive unit 2 is accelerated up to the ending of starting, in particular beginning from the speed of zero, drive unit 3 is operated in a speed-regulated manner. The hybrid drive device furthermore comprises a torque converter 5, which operatively connects the second drive unit 3 to the output 8. On the input side, the torque converter 5 has a pump impeller 6, which is rigidly connected to the drive shaft of the second drive unit 3. On the output side, the torque converter 5 has a turbine wheel 7, which is rigidly connected to the output 8. Within the torque converter 5 there is hydraulic fluid, which transmits a torque between the pump impeller 6 and the turbine wheel 7. The transmission capacity of the torque converter and hence the amount of torque which is actually transmitted increases as the speed difference between the turbine wheel 7 and the pump impeller 6 increases. The output 8 is connected to the driven wheels 15 of a vehicle by means of a transmission 13 via axles 14, for example. Here, the transmission can be a manual transmission, an automated shift transmission, a continuously variable transmission or an automatic transmission. FIG. 1 furthermore illustrates a control unit 12, which acquires signals from different sensors, e.g. a sensor device for detecting environmental information 11, a speed sensor 9 for detecting the speed of the pump impeller 6 or a speed sensor 10 for detecting the speed of the turbine wheel 7. The signals are evaluated within the control unit 12 and are used to regulate the speed of the second drive unit 3, for example. Consequently, the control unit 12 regulates the speed of the second drive unit 3.

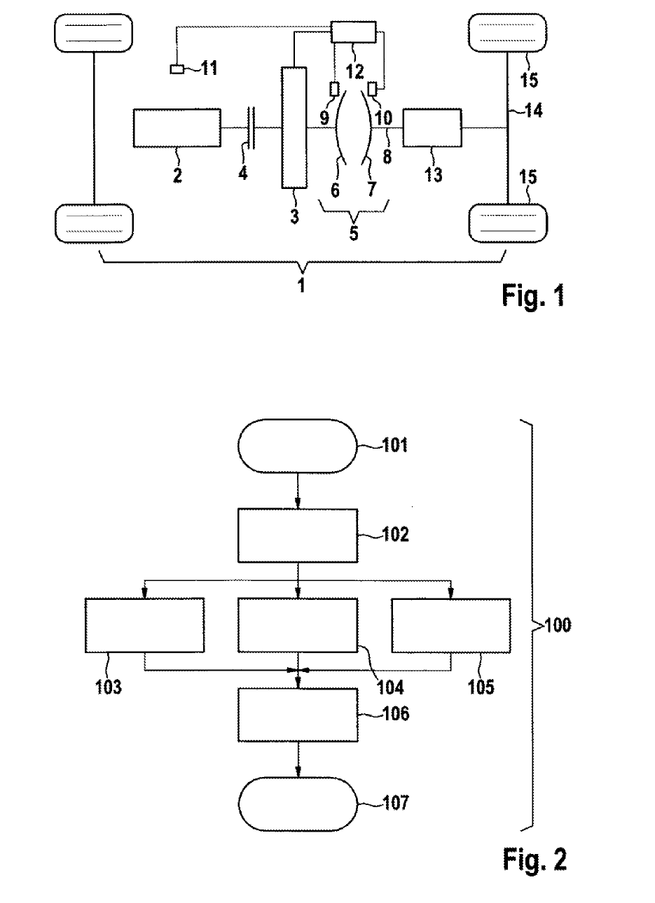

FIG. 2 shows an illustrative embodiment of a method 100 for operating a hybrid drive device 1. The method starts with step 101. In step 102, the method pauses until a signal for starting the first drive unit 2 is provided, in particular within the control unit 12. With the presence of the signal for starting the first drive unit, the method progresses by one step. 3 subroutines then run in parallel: in block 103, the system checks whether the starting of the first drive unit 2 is finished or complete, in block 104 the clutch 4 is at least partially closed, and in block 105 the speed of the second drive unit 3 is regulated. In one embodiment of the invention, the speed of the second drive unit 3 is regulated in such a way in block 105 that the speed difference 207 between the speed 10 of the turbine wheel 7 and the speed 9 of the pump impeller 6 remains constant and, in particular, the value of the speed difference 207 to be set is specified in accordance with a parameter value detected during the operation of the hybrid drive device 1, in particular immediately before the starting of the first drive unit 2, by means of the sensor device 11. If it is detected in block 103 that the starting of the first drive unit 2 is finished, the method progresses by one step. In block 106, the clutch 4 is operated, in particular once again independently of the illustrated method in block 104, and the second drive unit 3 is operated, in particular likewise once again independently of the illustrated method in block 105. The method 100 ends with step 107.

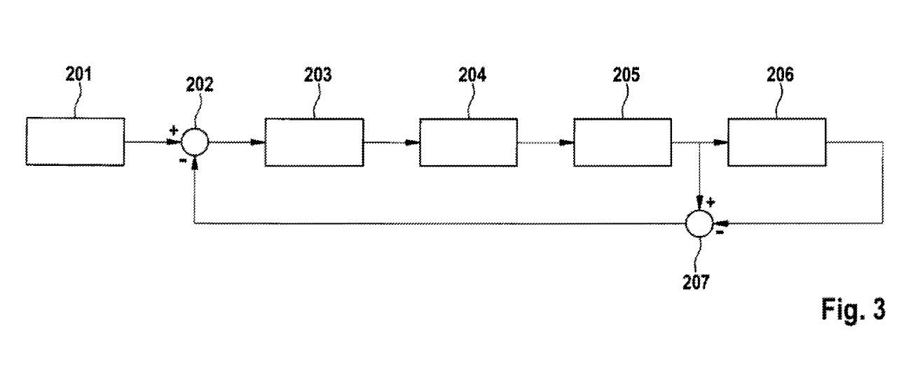

FIG. 3 shows an illustrative example of a control system for operating the hybrid drive device during the starting or a starting process of the first drive unit 2. With block 201, the desired speed difference, in particular constant desired speed difference, between the speed of the turbine wheel 7 detected by sensor 10 and the speed of the pump impeller 6 detected by sensor 9 is specified to the control section as a reference input variable. In particular, the value of the desired speed difference to be set is specified in accordance with a parameter value detected during the operation of the hybrid drive device 1, in particular immediately before the starting of the first drive unit 2, by means of the sensor device 11. In point 202, the control error is formed as the difference between the desired and the actual speed difference and fed to the controller 203. The output variable of the controller is used to control the second drive unit 3, 204. The second drive unit 3, 204 outputs a corresponding torque as an output variable to the pump impeller 6, 205 of the torque converter 5. Via the hydraulic oil in the torque converter 5, a torque is output to the turbine wheel 7, 206. Sensors 9 and 10 on the pump impeller 6, 205 and on the turbine wheel 7, 206 detect the respective speeds. In point 207, the actual speed difference is formed from the speeds detected at the pump impeller 6, 205 and at the turbine wheel 7, 206 and passed to point 202. There, the control error is once again formed as the difference between the desired and the actual speed difference and fed to the controller 203 again. The control circuit is thus closed and ensures that there is always a constant torque at the output 8 and comfortable and safe handling is made possible, even during the starting of a first drive unit 2. In particular, for reasons of the control rate in order to avoid latency, due to bus systems for example, this functionality should be implemented in the inverter or in the control unit for the electric machine.

1. A method for operating a hybrid drive of a motor vehicle, wherein the hybrid drive has at least one first drive unit and one second drive unit, wherein the first drive unit and the second drive unit can be operatively connected mechanically by means of a clutch, the method comprising:
starting the first drive unit by at least partially closing the clutch and thus accelerating the first drive unit by means of the second drive unit, and
regulating the speed of the second drive unit during starting of the first drive unit.

2. The method according to claim 1, wherein the hybrid drive device further includes a torque converter having a pump impeller and a turbine wheel and an output),
wherein the second drive unit and the pump impeller are connected mechanically to one another,
and wherein the turbine wheel is connected to the output),
and regulating the speed of the second drive unit is based on a speed of the turbine wheel.

3. The method according to claim 2, wherein the speed of the second drive unit is regulated based on a speed of the pump impeller.

4. The method according to claim 3, wherein the speed of the second drive unit is regulated in accordance with a speed difference between the speed of the turbine wheel and the speed of the pump impeller.

5. The method according to claim 4, wherein the speed of the second drive unit is regulated in such a way that the speed difference between the speed of the turbine wheel and the speed of the pump impeller remains constant.

6. The method according to claim 5, wherein the value of the speed difference (to be set between the speed of the turbine wheel and the speed of the pump impeller is specified in accordance with a parameter value detected by means of a sensor during the operation of the hybrid drive.

7. A controller for operating a hybrid drive of a motor vehicle, the hybrid drive having at least one first drive unit and one second drive unit,
wherein the first drive unit and the second drive unit can be operatively connected mechanically by means of a clutch,
and wherein the controller is configured to
control the clutch to start the first drive unit and so that the first drive unit is accelerated by the second drive unit,
regulate the speed of the second drive unit during starting of the first drive unit.

8. A hybrid drive for a motor vehicle, the hybrid drive comprising:
at least one first and one second drive unit,
a clutch, and
a controller,
wherein the first drive unit and the second drive unit can be operatively connected mechanically by means of the clutch,
and wherein the controller is configured to control the clutch to start the first drive unit when the clutch is at least partially closed and the first drive unit is thus accelerated by the second drive unit,
wherein the at least one controller regulates the speed of the second drive unit during the starting of the first drive unit.
